(19) United States
(12) Patent Application Publication
(10) Pub. No.: US 2004/0080272 A1
(43) Pub. Date: Apr. 29, 2004

(54) Dazzling lighting lamp

(76) Inventor: Wun Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/282,021

(22) Filed: Oct. 29, 2002

(51) Int. Cl. H01J 17/16; H01J 61/30

(52) U.S. Cl. 313/634

(57) ABSTRACT

The present invention relates to a dazzling lighting lamp wherein a film is provided on or in a shell of the lamp. The lamp emits light from multiple lighting spots through the film that obtains a dazzling lighting effect and reaches the purpose of this invention.

### BACKGROUND OF THE INVENTION

A conventional decorative tungsten lamp emits a single lighting spot, which is somehow monotonous, as shown in FIG. 1. There are some improvements, such as to provide a semi-transparent shell outside the lamp or to provide the lamp being semi-transparent, which obtains an effect only to change the single lighting spot to an uniform lighting source and is lack of specialty.

Accordingly, the primary object of the invention is to provide a dazzling lighting lamp, which has multiple lighting spots, in such interaction, to cause the dazzling effect. Now the features and advantages of the present invention will be described in detail with reference to the accompanying drawings.

### BRIEF DESCRIPTION OF ACCOMPANYING DRAWINGS

FIG. 1 is a perspective view showing a conventional tungsten lamp.

FIG. 2 is a perspective view showing a dazzling lighting lamp according to the present invention.

FIG. 3 is an enlarged plan view showing an embodiment with multiple lighting spots according to the present invention.

FIG. 4 is an enlarged plan view showing another embodiment with multiple lighting spots.

FIG. 5 is a perspective view showing an embodiment used on a miniature bulb according to the present invention.

FIG. 6 is a perspective view showing an embodiment used on a fluorescent lamp according to the present invention.

### DETAILED DESCRIPTION OF PREFERRED EMBODIMENTS

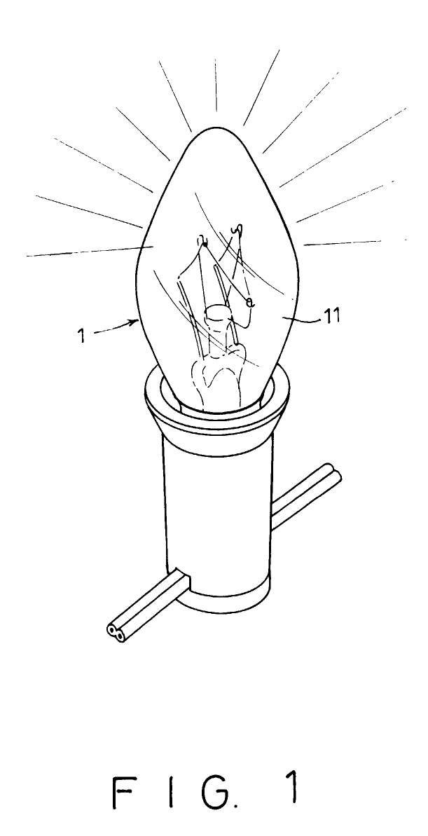

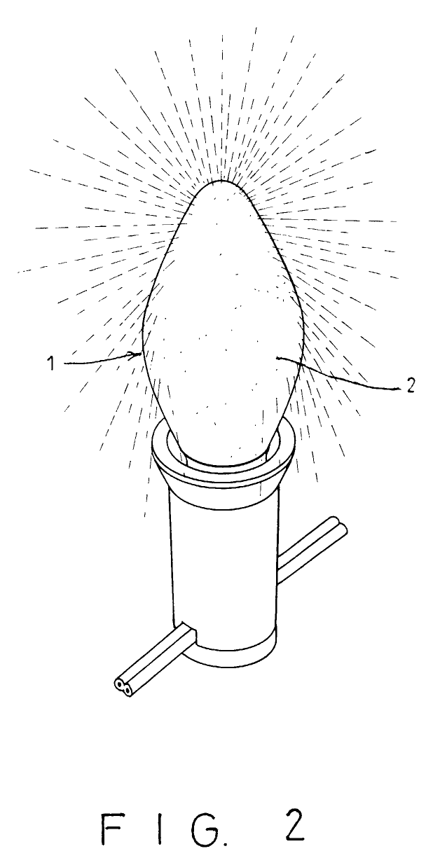

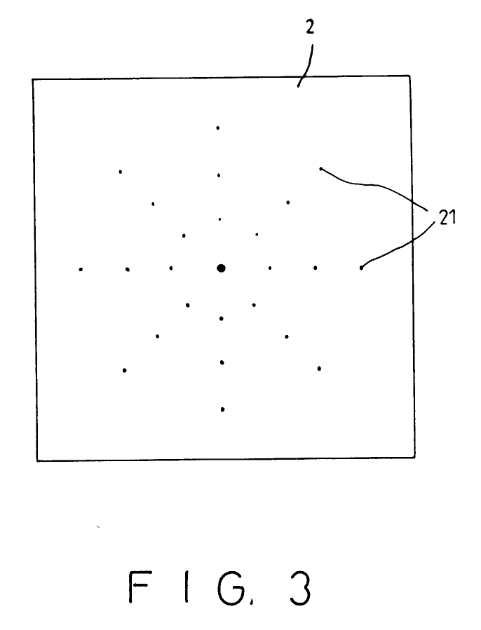

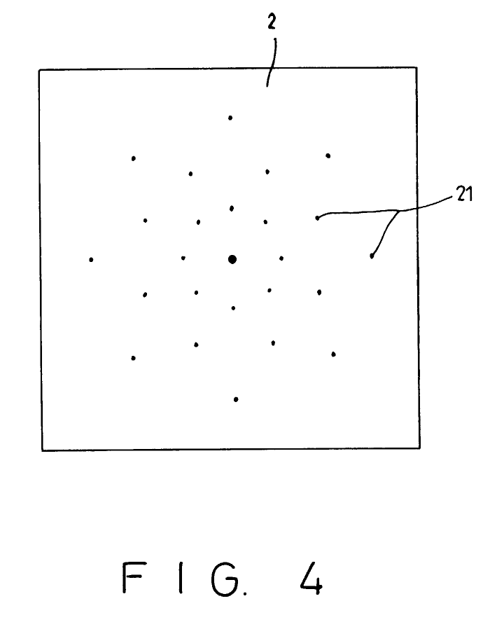

Please refer to FIG. 1 firstly, a conventional tungsten lamp (1) has a transparent shell (11) and the light emits with a single lighting spot. The characteristic of the present invention is to provide a film (2) outside the shell (11) of the lamp (1), as shown in FIG. 2. By use of the film (2), the prior single lighting spot can be transferred to multiple lighting spots (21) outward. FIGS. 3 and 4 are possible embodiments. Hence, under the multiple lighting spot (21), the emitting lights become a dazzling effect, which possesses decoration and variation and is better than the prior product.

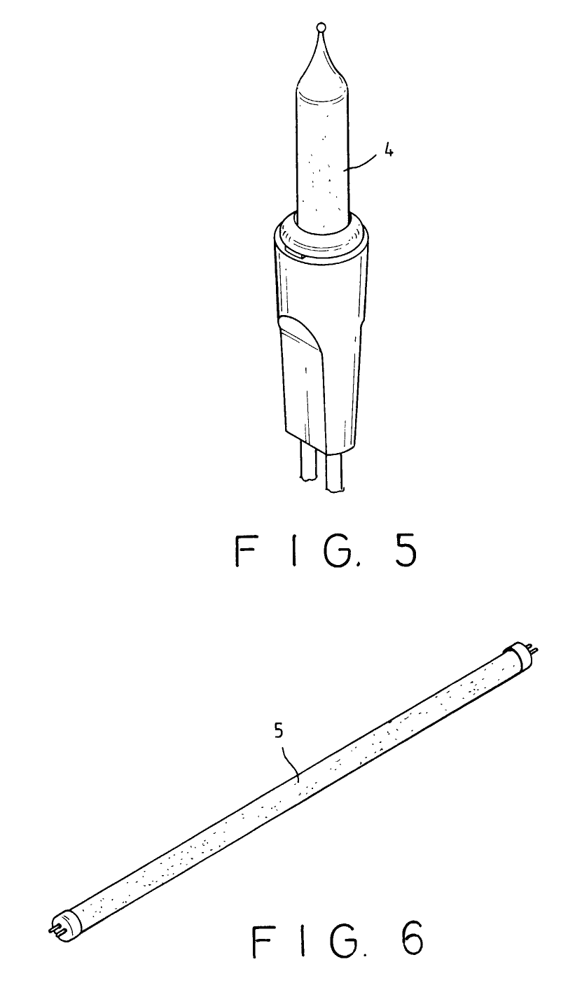

Based on the aforesaid structure, the structure can be used on a miniature bulb (4) shown in FIG. 5, or on a fluorescent lamp (5) shown in FIG. 6. Then, the miniature bulb (4) or the fluorescent lamp (5) can emit a dazzling lighting thereof because of change of the lighting spot.

Accordingly, the present invention obviously achieves utility and improvement that should be granted for patent.

What is claimed is:

1. A dazzling lighting lamp being characterized in that a film provided on or in a shell of the lamp in order that the lamp emits with a dazzling lighting effect by multiple lighting spots.
